(19) United States
(12) Patent Application Publication
(10) Pub. No.: US 2003/0230199 A1
(43) Pub. Date: Dec. 18, 2003

(54) Pot cover structure

(76) Inventor: Li-Sui Huang, Chia Yi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/173,396

(22) Filed: Jun. 18, 2002

(51) Int. Cl. A47J 37/12

(52) U.S. Cl. 99/403

(57) ABSTRACT

A pot cover structure includes a cover and a number of clips, the center bottom of the cover is formed with a rim of wall with at least of two holes on the wall for the clips to secure therein, each clip has a stop section at the top portion, a contact section at the center portion and a block extending from the contact section downwardly, the block has a pair of clipper edges extending there from, the clips are equally set along the wall of the cover, when the cover is placed onto the pot, the stop section slows down the movement to prevent an abrupt engagement.

### FIELD OF THE INVENTION

This invention relates to the structure of a pot cover, and more particularly, to a pot cover that can seal with the pot firmly.

### BACKGROUND OF THE INVENTION

There are many pots of different designs on the market. A conventional pot is made of ceramic or glass with a wall extending downwardly from the center bottom portion of the cover, with at least two holes equally spaced from each other, and an elastic ring in the wall, the elastic ring is formed with bulging areas corresponding to the holes and extending outwardly from the holes, so that when the cover covers the pot, a portion of which exposed outwardly from the hole and engaging with the pot.

This conventional design of cover can hold the pot firmly, however, due to the strength of the elastic ring, the cover is hard to pull away, further, when pushing the cover onto the pot, if the pushing force is applied to hard, the pot mouth or the cover may be broken.

### SUMMARY OF THE INVENTION

It is the primary object of the present invention to provide a renovated structure of a pot cover, which buffers the movement of the cover from pushing into and pulling away of the pot, so as to reduce possibility of breaking the pot or the cover.

It is another object of the present invention to provide a renovated structure of a pot cover, which is easy to operate.

It is a further object of the present invention to provide a renovated structure of a pot cover, which is safe in use.

### BRIEF DESCRIPTION OF THE DRAWINGS

FIG. 1 is an exploded view of the present invention;

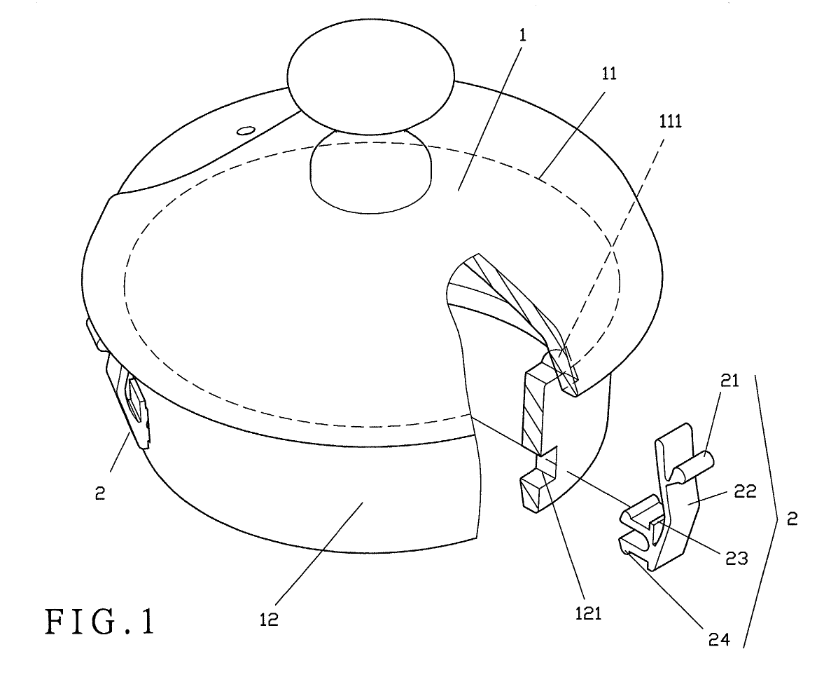

FIG. 2 is a side cross sectional view of FIG. 1;

FIG. 3 is a cross-sectional showing the cover of the present invention incorporated with a pot, before sealing;

FIG. 4 is a cross-sectional view showing an assembly of the present invention with the pot;

FIG. 5 is an exploded view of a second embodiment of the present invention;

FIG. 6 is a cross-sectional view showing the second embodiment of the present invention incorporated with a pot, before sealing; and

FIG. 7 is a cross-sectional view showing an assembly of the second embodiment of the present invention with the pot.

### DETAILED DESCRIPTION OF THE PREFERRED EMBODIMENTS

The renovated structure of a pot cover of the present invention comprises a cover 1, and a number of clips 2.

The cover 1 is made of either ceramic or glass material, having an edge 11 extending downwardly from center of the cover, a number of holes 111 being formed on the edge 11 and equally spaced from each other, a wall 12 being formed along the edge 11 towards the center portion of the cover 1 with holes 121 thereon.

The clip 12 is made of plastic material, has a stop section 21 at the top portion thereof, a contact section 22 at the center portion and protruding outwardly there from, a block 23 being formed at the bottom portion and a pair of clipper edges 24 extending upwardly from the block 23 and in parallel with each other.

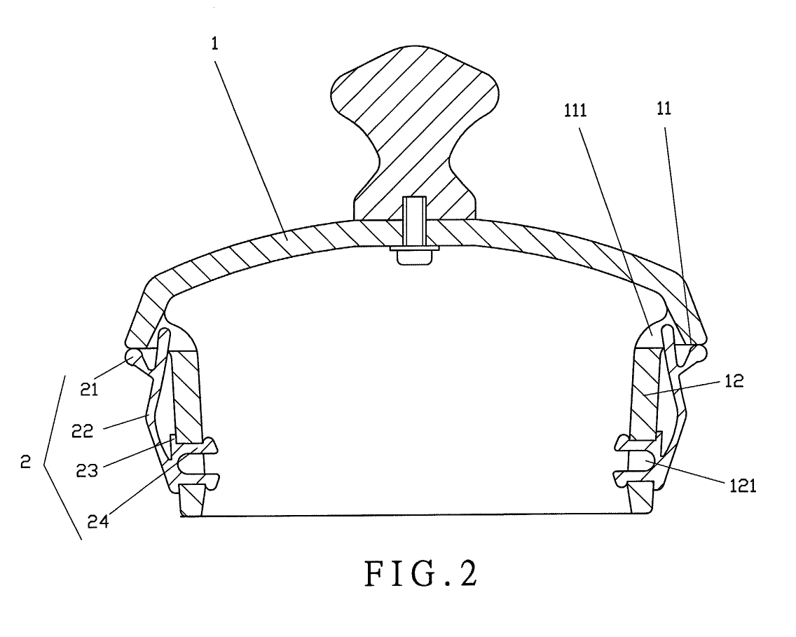

To assemble the present invention, each of the clips 2 is inserted into the relative hole 111 of the cover 1 with the clip edge 24 inserted into the relative hole 121 all the way to its bottom end of the hole, as shown in FIG. 2, the block 23 is placed against the hole 121 and engaged with the edge of the wall 12. At least two clips 2 are placed on the wall 12, thus the cover 1 of the present invention is formed.

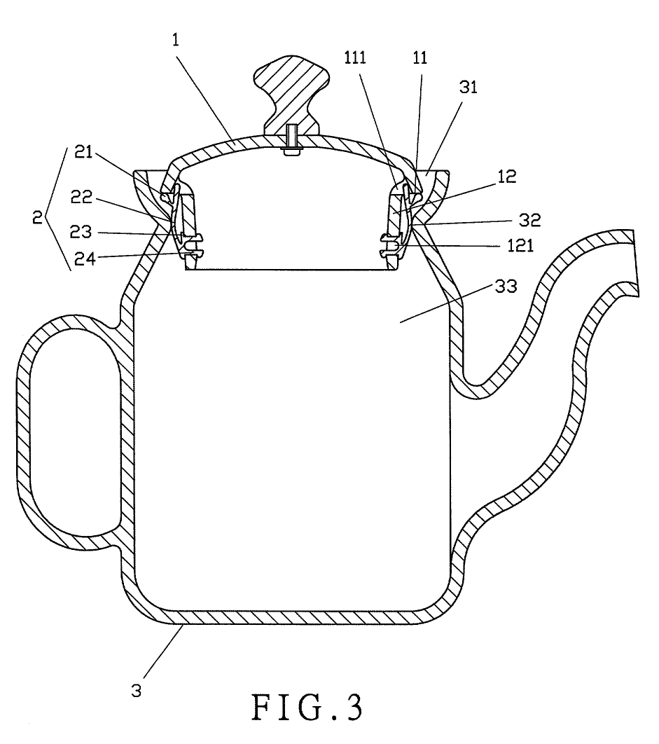

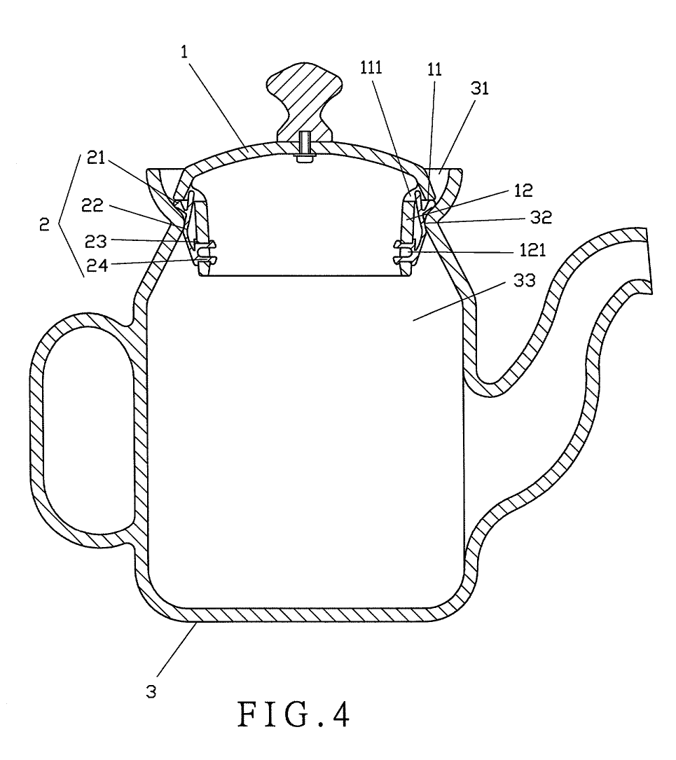

When closing a pot 3 with the cover 1, as shown in FIGS. 3 and 4, a mouth 31 of the pot 3 is formed with a smaller diameter at its neck 32, and then gradually enlarging at its body 33. When enclosing the cover 1 to the pot 3, the contact section 22 of the clip 2 of the cover 1 will engage with the inside of the neck 32, which presses the contact section 22 inward and allows the cover 1 to be in touch with the neck 32 direct, upon the clip 2 passes through the neck 32, the contact section 22 returns to its original position and engages with the lower end portion of the neck 32. To open the cover 1, the cover 1 is pulled up, which will bring the contact section 22 of the clip 2 slide through the neck 32 of the pot 3, which squashes the contact section 22 inwardly and returns to its original position till they pass the neck 32.

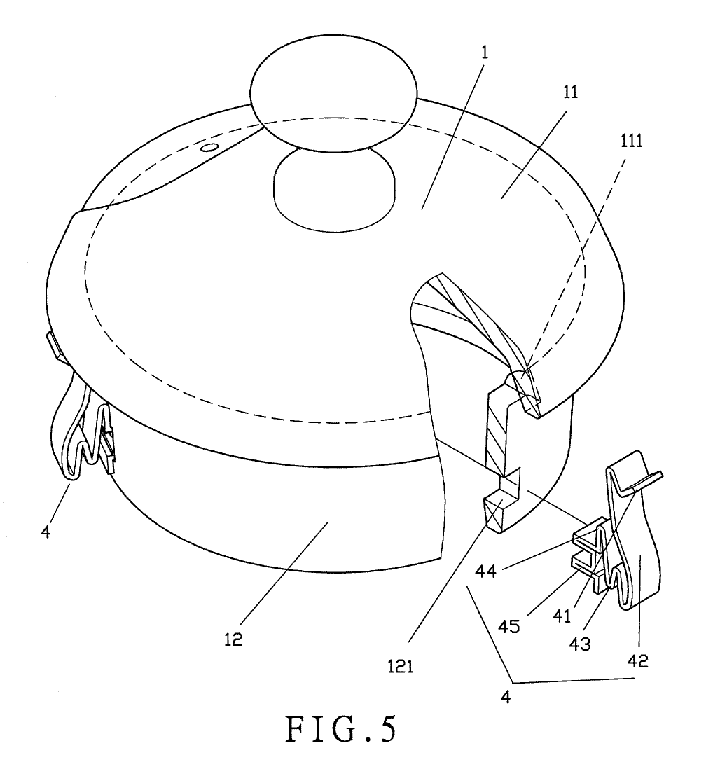

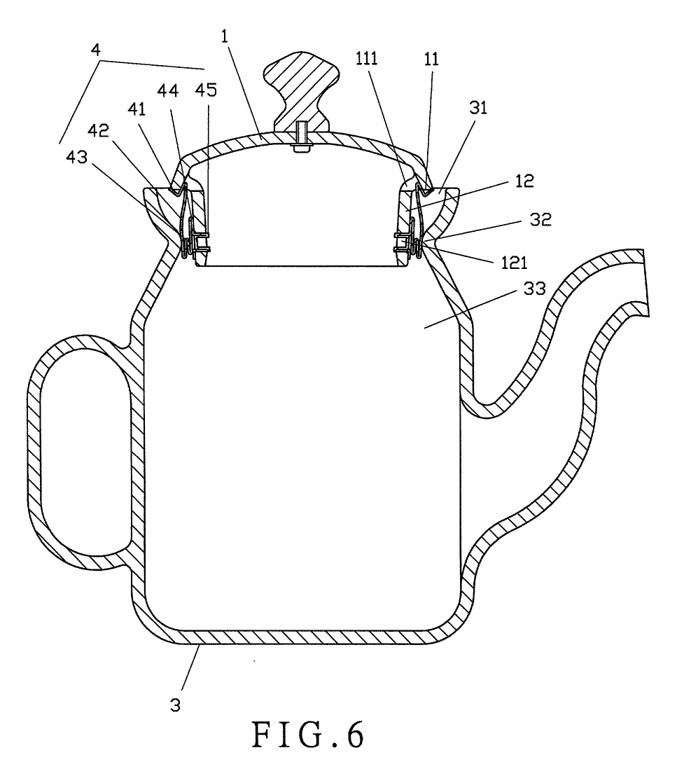

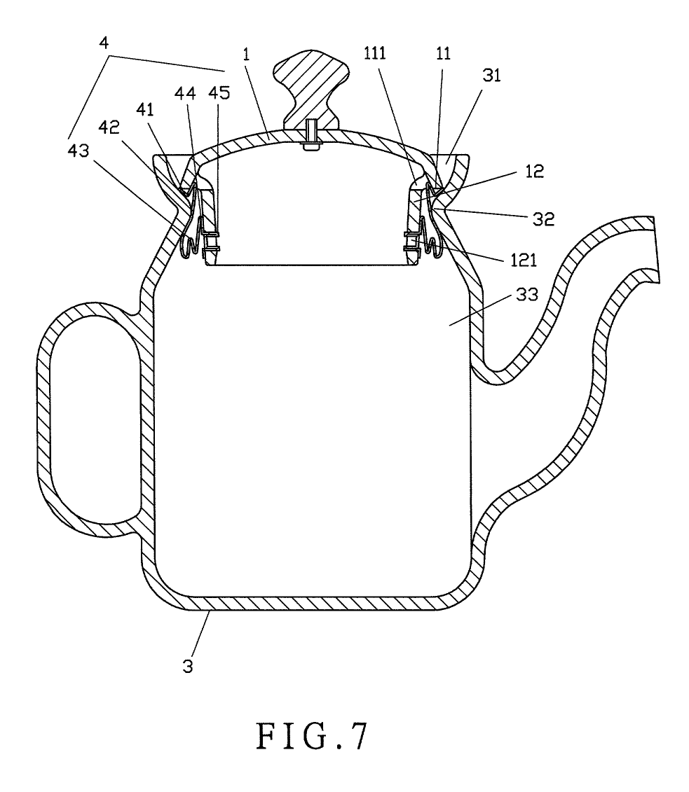

FIG. 5 shows a second embodiment, a clip 4 is made of metal material, the clip 4 comprises a stop section 41 bending outwardly from the top portion of the clip 4, a contact section 42 bending outwardly from the center portion, and a buffer section 43 extending downwardly from the contact section 42, a block 44 extending from the endmost of the buffer section 43, and a pair of clipper edges 45 on the block 44. The bending degree of the buffer section 43, between the contact section 42 and the block 44, is adjustable depending on the distance between the cover 1 and the pot neck 32. When closing the cover 1 onto the pot 3, as shown in FIGS. 6 and 7, the stop section 41 of the clip 4 buffers the pressing force of the cover 1 against the pot 3, upon the contact section 42 passes the neck 32 of the pot 3, the contact section 42 returns to its original position and engages with the lower end of the neck 32, thus the cover 1 is held at place.

In this embodiment, the bending format of the clip 4 depends on the distance between the cover 1 and the pot 3, this shall leave no space between the cover 1 and the pot 3.

Therefore, the cover 1 of this design has at least two clips 2 or 4, equally spaced from each other along the wall 12 of the cover 1, so that they may engage with the mouth 31, evenly, which is helpful both in open and close of the cover 1.

I claim:

1. A pot cover structure comprising a cover and a plurality of clips, wherein said cover having an edge extending from center portion thereof with a plurality of holes around said edge to accommodate said clips therein, and being characterized in that,
each of said clips comprising a stop section at the top end thereof, a contact section at the center and a block extending downward from said contact section, said block further comprising a pair of clipper edges extending outwardly therefrom, when said cover being closed onto a pot, said contact section of said clip buffering a pushing force preventing a direct and abrupt contact of said cover and said pot.

2. The pot cover structure, as recited in claim 1, wherein a buffer section between said contact section and said block is folded into several sections to increase its elastic force.
